(19) United States
(12) Patent Application Publication
(10) Pub. No.: US 2024/0185493 A1
(43) Pub. Date: Jun. 6, 2024

(54) NETWORK FOR STRUCTURE-BASED TEXT-TO-IMAGE GENERATION

(71) Applicant: Intel Corporation, Santa Clara, CA (US)

(72) Inventors: Peixi Xiong, Hillsboro, OR (US); Nilesh Jain, Portland, OR (US)

(21) Appl. No.: 18/400,561

(22) Filed: Dec. 29, 2023

(51) Int. Cl. G06T 11/60; G06F 40/205; G06F 40/284

(52) U.S. Cl. CPC G06T 11/60; G06F 40/205; G06F 40/284

(57) ABSTRACT

Technology as described herein provides for generating an image via a generator network, including extracting structural relationship information from a text prompt, wherein the structural relationship information includes sentence features and token features, generating encoded text features based on the sentence features and on relation-related tokens, wherein the relation-related tokens are identified based on parsing text dependency information in the token features, and generating an output image based on combining, via self attention and cross-attention layers, the encoded text features and encoded image features from an input image canvas. Embodiments further include applying a gating function to modify image features based on text features. The self attention and cross-attention layers can be applied via a cross-modality network, the gating function can be applied via a residual gating network, and the relation-related tokens can be further identified via an attention matrix.

### BACKGROUND

Artificial intelligence (AI) systems use trained models to operate on input text data to produce an output image. Text input that is lengthy, dense, and filled with intricate relational information presents a challenge for conventional text-to-image generation techniques. Traditional image generation methods, which rely on short and straightforward text prompts, are unable to effectively capture and translate intricate relationships from text to the corresponding image output.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1B provide block diagrams illustrating examples of a text-to-image generation system according to one or more embodiments;

FIGS. 2A-2C provide block diagrams illustrating an example of a generator network for use in a text-to-image generation system according to one or more embodiments;

FIG. 3 provides a block diagram illustrating an example of a relation enhancing module for use in a generator network according to one or more embodiments;

FIGS. 4A-4C provide diagrams illustrating an example of a multimodality alignment module for use in a generator network according to one or more embodiments;

FIG. 5 provides a block diagram illustrating an example of a discriminator network for use in a text-to-image generation system according to one or more embodiments;

FIG. 6A provides a flow diagram illustrating an example method of generating an image via a generator network according to one or more embodiments;

FIG. 6B provides a flow diagram illustrating an example method of training a generator network according to one or more embodiments;

FIG. 7 provides a block diagram illustrating an example performance-enhanced computing system according to one or more embodiments;

FIG. 8 provides a block diagram illustrating an example semiconductor apparatus according to one or more embodiments;

FIG. 9 is a block diagram illustrating an example processor core according to one or more embodiments; and

FIG. 10 is a block diagram illustrating an example of a multi-processor based computing system according to one or more embodiments.

### DESCRIPTION OF EMBODIMENTS

Embodiments relate generally to artificial intelligence (AI) systems and deep learning (DL) technology. More particularly, embodiments relate to structure-based text-to-image generation. The technology described herein enables the efficient interpretation and reflection of complex relational structures present in lengthy text inputs during image generation through a model called the Understanding and Alignment Generative Adversarial Network (UnA-GAN), which is tailored to grasp structural details in text prompts and synchronize features across modalities. The UnA-GAN integrates modules within a GAN-like structure that provide for emphasizing relation-related features, enhancing text comprehension and visual-text coherence, and correcting for disturbances in informative tokens. Together, these modules ensure the generated images accurately reflect and align with the relational context of the input text.

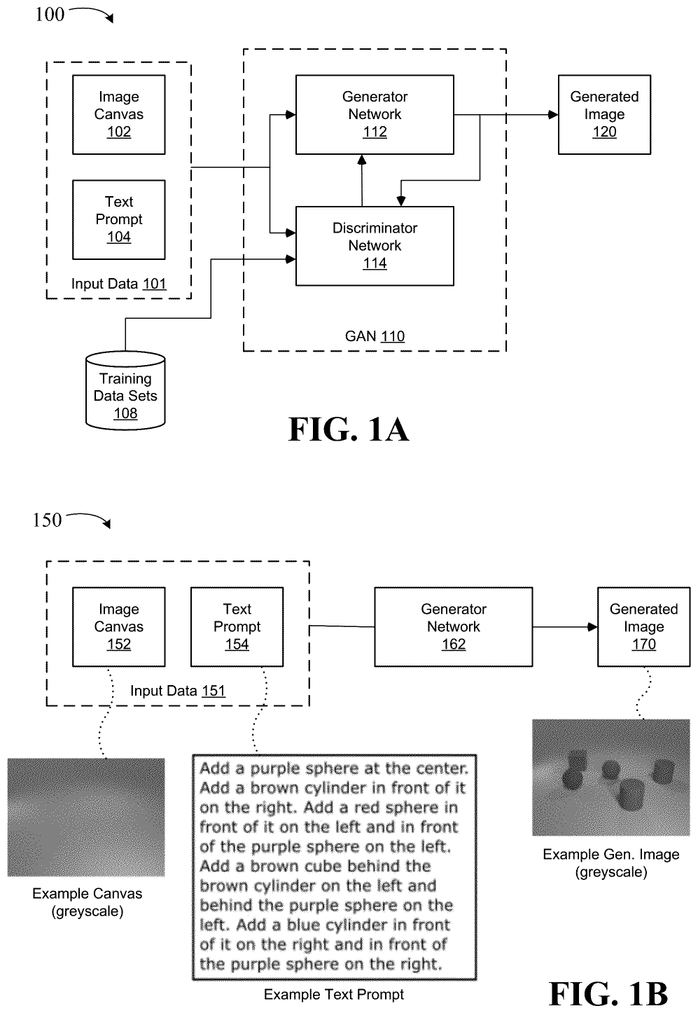

FIG. 1A provides a block diagram illustrating an example of a text-to-image generation system 100 according to one or more embodiments, with reference to components and features described herein including but not limited to the figures and associated description. As shown in FIG. 1A, the text-to-image generation system 100 is illustrated in a training mode (e.g., learning mode) and includes a generative adversarial network (GAN) 110. The GAN 110 includes a generator network 112 and a discriminator network 114 which is in data communication with the generator network 112. As such, the GAN 110 resembles aspects of a traditional generative adversarial network, but the GAN 110 and components thereof include significant differences as described herein throughout. The GAN 110 receives input data 101, which includes an image canvas 102 and a text prompt 104 that are each fed to the generator network 112 and the discriminator network 114. The image canvas 102 provides image data that serves as a background or starting image (e.g., scene) for the text-to-image system 100. The text prompt 104 represents text input that describes the image to be generated, and includes relational information to guide the text-to-image generation.

The training data sets 108 include examples of paired images and text and unpaired images and text, and are provided to the discriminator network 114. The paired images and text include text prompts with corresponding images that include the visual features described by the text prompts.

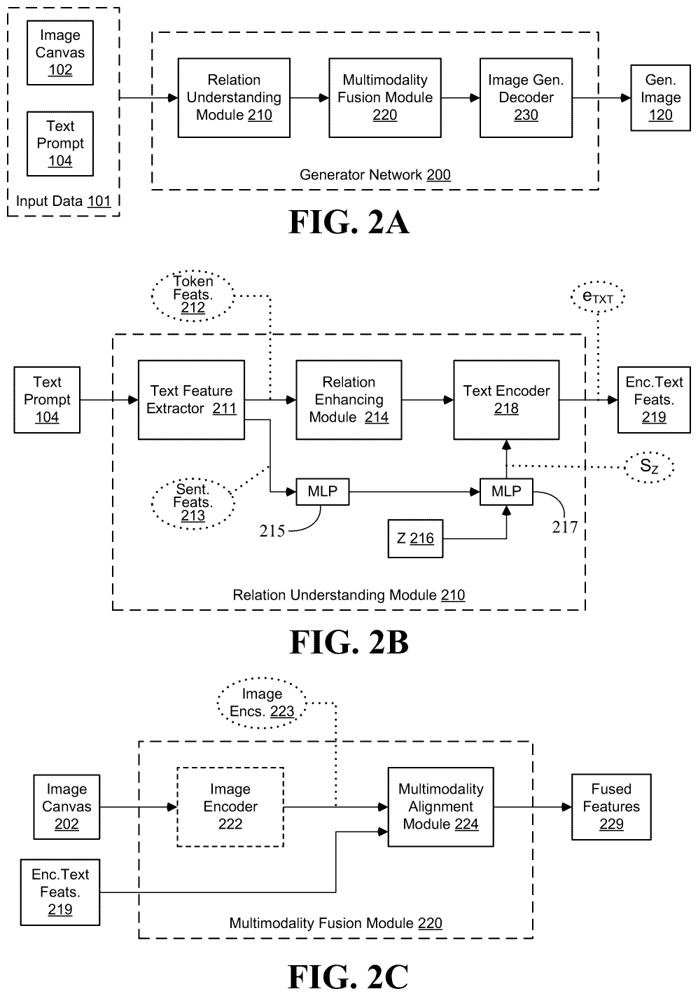

In operation during training, the generator network 112 sequentially produces a series of generated images 120, e.g., a generated image 120 is produced, which is fed back to the discriminator network 114 and the generator network 112 produces a revised generated image 120 that is fed back to the discriminator network 114, etc. The discriminator network 114 is to distinguish between samples and provide training feedback (e.g., to the generator network). Further details regarding the generator network 112 and the discriminator network 114 are provided herein with reference to FIGS. 2A-2C, 3, 4A-4C and 5.

FIG. 1B provides a block diagram illustrating an example of a text-to-image generation system 150 according to one or more embodiments, with reference to components and features described herein including but not limited to the figures and associated description. As shown in FIG. 1B, the text-to-image generation system 150 is illustrated in an inference mode and includes a trained generator network 162. The generator network 162 corresponds to a trained version of the generator network 112 (FIG. 1A, already discussed) that is trained as discussed herein. The generator network 162 receives input data 151, which includes an image canvas 152 and a text prompt 154. The image canvas 152 provides image data that serves as a background or starting image (e.g., scene) for the text-to-image system 150. The text prompt 154 represents text input that describes the image to be generated, and includes relational information to guide the text-to-image generation. In operation during inference, the generator network 162 produces a generated image 170 as an output result based on the image canvas 152 and the text prompt 154.

Some or all components and/or features in the text-to-image generation system 100 and/or the text-to-image generation system 150 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the text-to-image generation system 100 and/or the text-to-image generation system 150 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the text-to-image generation system 100 and/or the text-to-image generation system 150 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 2A provides a block diagram illustrating an example of a generator network 200 for use in a text-to-image generation system according to one or more embodiments, with reference to components and features described herein including but not limited to the figures and associated description. In embodiments, the generator network 200 corresponds to the generator network 112 (FIG. 1A, already discussed) and/or the generator network 162 (FIG. 1B, already discussed). As shown in FIG. 2A, the generator network 200 includes a relation understanding module 210, a multimodality fusion module 220, and an image generator decoder 230. When operating in training mode, the generator network 200 receives as input the input data 101, which includes the image canvas 102 and the text prompt 104. When operating in inference mode, the generator network 200 receives as input the input data 151 (not shown in FIG. 2A), which includes the image canvas 152 and the text prompt 154.

The relation understanding module 210 operates to extract structural relationship information from the text prompt 104 (training mode) or the text prompt 154 (inference mode) and embed these enhanced relations into a text encoder. The structural relationship information includes sentence features and token features, to produce text encodings. The relation understanding module 210 further operates to generate encoded text features based on the sentence features and relation-related tokens, where the relation-related tokens are identified based on parsing text dependency information in the token features, thereby focusing on relation-related tokens during the generation phase. Further details regarding the relation understanding module 210 are provided herein with reference to FIG. 2B.

The multimodality fusion module 220 combines (e.g., fuses or merges) encoded image (e.g., visual) features and relation-enhanced text features, thereby enhancing text comprehension and visual-text alignment. The multimodality fusion module 220 operates by applying self attention and cross-attention layers and applying a gating function to modify image features based on text features. The encoded image features are provided from an image encoder. The text features are from the text encodings produced by the relation understanding module 210. Further details regarding the multimodality fusion module 220 are provided herein with reference to FIG. 2C.

The image generator decoder 230 includes a set of upsampling residual layers. The image generator decoder 230 operates to generate an output image (e.g., the generated image 120) based on the fused image and text features from the multimodality fusion module 220.

Some or all components and/or features in the generator network 200 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the generator network 200 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the generator network 200 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 2B provides a block diagram illustrating an example of a relation understanding module 210 for use in a generator network (such as the generator network 200 in FIG. 2A) according to one or more embodiments, with reference to components and features described herein including but not limited to the figures and associated description. As shown in FIG. 2B, the relation understanding module 210 includes a text feature extractor 211, a relation enhancing module 214, a first multilayer perceptron 215, a second multilayer perceptron 217, and a text encoder 218. The relation understanding module 210 receives as input a text prompt (e.g., the text prompt 104 in training mode or the text prompt 154 in inference mode), and produces encoded text features 219.

The text feature extractor 211 includes a text encoder such as, e.g., a BERT (Bidirectional Encoder Representations from Transformers)-based encoder. Using tools from a natural language processing package such as, e.g., the Natural Language Toolkit (NLTK), the text feature extractor 211 operates on the text prompt 104 (training mode) or the text prompt 154 (inference mode) to produce token features

$$( f = {\{ {f}_{i} \}}_{i = 0}^{N} ) \qquad 212$$

and context-attended sentence features (S) 213. The sentence features 213 provide information to describe the sentence (e.g., text prompt) holistically, and has a length of one element (e.g., covering the text prompt as a whole). The token features 212 are elements that describe a sentence at the level of individual tokens—e.g., in natural language processing, a token is essentially a word or a distinct piece of text. A part-of-speech (POS) tag is a label assigned to each token (e.g., word) in the text prompt to indicate its part of speech, such as noun, verb, adjective, etc. The length of these features (e.g., number of elements N) is similar to the length of the sentence (text prompt), including, e.g., an end-of-sentence tag (<EOS>) and/or a padding tag (<PAD>). Informative tokens are defined as attributes (e.g., nouns, adjectives, etc.) and relations (e.g., adpositions, verbs) based on tokens in the sentence from the Part-of-Speech Tagset (POS tag).

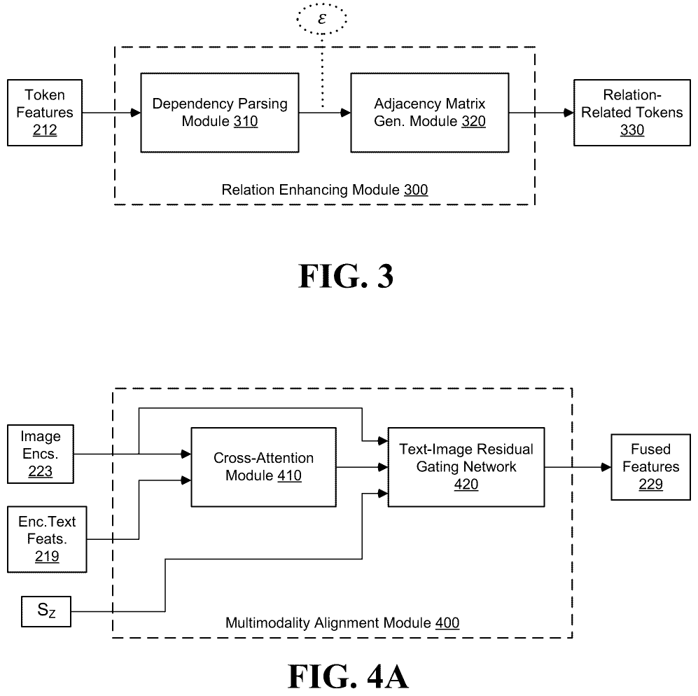

The relation enhancing module 214 operates on the token features 212 to produce relation-related tokens which are fed into the text encoder 218. The relation enhancing module 214 parses dependency information, guiding self-attention learning. Further details regarding the relation enhancing module 214 are provided herein with reference to FIG. 3.

The sentence features 213 are transformed by the first multilayer perceptron 215 to produce an output that is concatenated with a noise vector fed to the second multilayer perceptron 217. The second multilayer perceptron 217 receives the output of the first multilayer perceptron 215 and a random noise vector 216, z˜ [symbol] (0, I)∈ [symbol] ^{N}^{_{Z}}, where 0 is the mean of the multivariate normal distribution, and I (the identity matrix) is a covariance matrix—thus the elements of the noise vector z are uncorrelated and each has a variance of 1. The second multilayer perceptron 217 produces features S_{Z} that are fed to the text encoder 218. The features S_{Z} are randomized sentence features (e.g., randomized resulting from the concatenation with the noise vector as described above). Adding randomness to the sentence features enhances the system by providing for diversity in outputs generated, effective exploration of the latent space, and prevention of overfitting.

The text encoder 218 receives the relation-related tokens from the relation enhancing module 214 and the output of the second multilayer perceptron 217 to encode both sentence-level and token-level features, producing relation-enhanced encoded text features 219. The text encoder 218 is a transformer-based encoder that includes a Multi-Head Attention (MHA) network to generates an attention map. While conventional transformer-based encoders have the MHA generate an attention map that is learned from scratch, for the text encoder 218 here an adjacency matrix A (as described further herein with reference to FIG. 3) is applied as a soft mask to guide the learning of attention by the MHA of the text encoder 218. That is, to encode sentence-level and token-level features, the text encoder 218 is guided by the dependency graph/structure(ϵ) and indexes of relation-related tokens

$$( i d = {\{ i {d}_{j} \}}_{j = 0}^{D} ) :$$

\tilde{f}=MHA(f, G_{GUIDE}=A[ϵid]) EQ. 1
where the output encoded text features 219 of the text encoder 218, e_{TXT}, is:

e_{TXT}=CONCAT(\tilde{f}, S_{Z}) EQ. 2

Thus, the multi-head attention block (MHA) of the the text encoder 218 learns self-attention for token features, using the adjacency matrix A[ϵ,id] as a soft attention mask to guide focus on natural language relations and emphasize relation-related tokens. These relation-enhanced features are concatenated with the randomized sentence features S_{Z}, forming text-enhanced features (e_{TXT}) as the encoded text features 219, to be input to the multimodality fusion module 220.

Some or all components and/or features in the relation understanding module 210 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the relation understanding module 210 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the relation understanding module 210 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

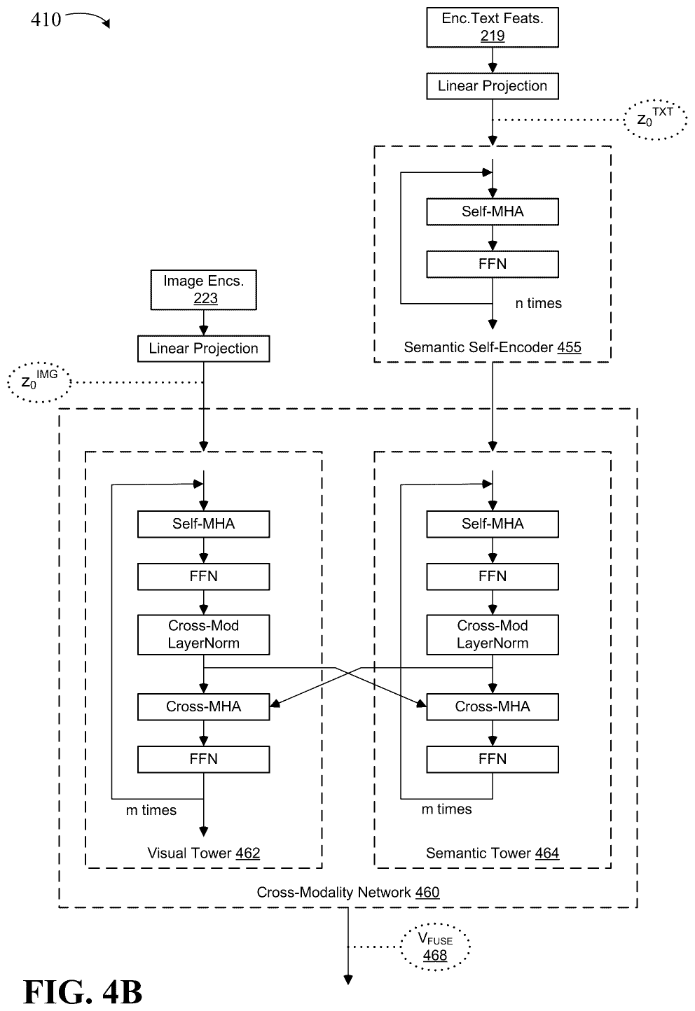

FIG. 2C provides a block diagram illustrating an example of a multimodality fusion module 220 for use in a generator network (such as the generator network 200 in FIG. 2A) according to one or more embodiments, with reference to components and features described herein including but not limited to the figures and associated description. As shown in FIG. 2C, the multimodality fusion module 220 includes a multimodality alignment module 224 that receives the encoded text features 219 from the relation understanding module 210 (FIG. 2A, already discussed) and image encodings 223. The image encodings 223 are generated based on an image canvas 202. In training mode, the image canvas 202 corresponds to the image canvas 102, and in inference mode the image canvas 202 corresponds to the image canvas 152. In embodiments, the multimodality fusion module 220 includes an image encoder 222 that generates the image encodings 223. The image encoder 222 includes a residual convolutional network that downsamples the image features. In some embodiments, the image encoder that generates the image encodings 223 is external to the multimodality fusion module 220. The multimodality fusion module 220 produces fused features 229 (e.g., fused image and text features). Further details regarding the multimodality alignment module 224 are provided herein with reference to FIGS. 4A-4C.

Some or all components and/or features in the multimodality fusion module 220 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the multimodality fusion module 220 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the multimodality fusion module 220 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 3 provides a block diagram illustrating an example of a relation enhancing module 300 for use in a relation understanding module (such as the relation understanding module 210 in FIG. 2B) according to one or more embodiments, with reference to components and features described herein including but not limited to the figures and associated description. As shown in FIG. 3, the relation enhancing module 300 includes a dependency parsing module 310 and an adjacency matrix generating module 320.

The dependency parsing module 310 uses a dependency parser from a natural language processing package such as, e.g., the Natural Language Toolkit (NLTK), to parse dependency information from the token features 212. Dependency parsing involves analyzing the grammatical structure of a sentence by identifying the dependencies between words, which helps in understanding how different parts of a sentence are related to each other in terms of grammar and meaning. A dependency parser is a tool used for analyzing the grammatical structure of sentences by establishing the dependencies between words. The parser identifies relationships between words, such as which words are the subjects, objects, or modifiers of others, thereby allowing a deeper understanding of the sentence's syntax and meaning. The dependency parser generates a dependency graph/structure (ϵ) that provides dependency information between tokens from the text prompt (e.g., the text prompt 104 in training mode or the text prompt 154 in inference mode).

The adjacency matrix generating module 320 converts the dependency graph/structure (ϵ) to generate the adjacency matrix A[ϵ,id] and relation-related tokens 330. Each cell of the adjacency matrix A[ϵ,id] indicates related tokens by index—e.g., the cell for row i and column j indicates whether a token i is related to a token j. In embodiments, the cell values of the adjacency matrix A[ϵ,id] are 0 or 1, where 0 indicates no relationship and 1 indicates a relationship between tokens. The adjacency matrix A[ϵ,id] is a learnable matrix and, in embodiments, the adjacency matrix is generated according to the following process:
(1) Identify Nodes and Dependencies: First, determine the nodes (the tokens/words in the sentence) and the dependencies between them from the dependency graph (ϵ). Each node and each dependency relation will be represented in the adjacency matrix.
(2) Create a Matrix: Initialize a square matrix where the number of rows and columns is equal to the number of tokens in the sentence. In some embodiments, a root node is included and the size of the rows and columns is the number of tokens plus one.
(3) Evaluate each dependency in the dependency graph (ϵ):
(a) For a dependency from token A to token B, mark the cell at the intersection of row A and column B in the matrix. In embodiments, the marking is binary (1 for a dependency, 0 for no dependency). In some embodiments, the marking is a numerical value representing the type or strength of the dependency.
(b) Where there are multiple types of dependencies, different values are used to represent each of the different types.
(c) In embodiments, self-dependencies (e.g., a word depending on itself) are marked as 0. In some embodiments, self-dependencies are marked with a different value.
(4) Finalize the Matrix: After filling in all the dependencies, the adjacency matrix is complete. Each row and column represents a token, and the values in the matrix cells indicate the dependencies between these tokens, thus identifying the relation-related tokens

$$( r = {\{ {r}_{i} \}}_{i = 0}^{N} ) 330.$$

Some or all components and/or features in the relation enhancing module 300 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the relation enhancing module 300 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the relation enhancing module 300 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4A provides a block diagram illustrating an example of a multimodality alignment module 400 for use in a generator network (such as the generator network 200 in FIG. 2A) according to one or more embodiments, with reference to components and features described herein including but not limited to the figures and associated description. As shown in FIG. 4A, the multimodality alignment module 400 includes a cross-attention module 410 and a text-image residual gating network 420. The multimodality alignment module 400 receives as input the encoded text features 219 and the randomized sentence features S_{Z} (FIG. 2B, already discussed), along with the image encodings 223 (FIG. 2C, already discussed), and generates fused features 229. The fused features 229, which represent a combination of aligned visual and text features, are to be fed into the image generator decoder 230 (FIG. 2A, already discussed). The cross-attention module 410 merges visual and semantic streams via a cross-modality network, and the text-image residual gating network 420 composes visual-fused and text-enhanced features. Further details regarding the cross-attention module 410 are provided herein with reference to FIG. 4B, and further details regarding the text-image residual gating network 420 are provided herein with reference to FIG. 4C.

Some or all components and/or features in the multimodality alignment module 400 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the multimodality alignment module 400 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the multimodality alignment module 400 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4B provides a block diagram illustrating an example of a cross-attention module 410 for use in a multimodality alignment module (such as the multimodality alignment module 400 in FIG. 4A) according to one or more embodiments, with reference to components and features described herein including but not limited to the figures and associated description. As shown in FIG. 4B, the cross-attention module 410 includes a semantic self-encoder 455 and a cross-modality network 460, which in turn includes, in embodiments, a visual tower 462 and a semantic tower 464. The cross-attention module 410 receives the encoded text features 219 (FIG. 2B, already discussed) and the image encodings 223 (FIG. 2C, already discussed), and produces semantic-attended visual features (V_{FUSE}) 468.

The encoded text features 219 are fed via a first linear projection network (that provides a semantic feature (Z₀^{TXT})) into the semantic self-encoder 455. The semantic self-encoder 455 includes a self-MHA network and a feed-forward network (FFN), and iterates n times to provide for further self-attention learning that is then fed into the semantic tower 464. In some embodiments, n is equal to 3, such that the semantic self-encoder 455 iterates (e.g., via a loop) 3 times; however, other values of n can be used. The image encodings 223 are fed via a second linear projection network (that provides (Z₀^{IMG})) into the visual tower 462.

Each of the visual tower 462 and the semantic tower 464 has a series of layers, including a self-MHA network, a first FFN, a cross-modality layernorm, a cross-MHA network, and a second FFN. As illustrated in FIG. 4B, intermediate features from the cross-modality layernorm of the visual tower 462 are fed each iteration into the cross-MHA network of the semantic tower 464 Likewise, intermediate features from the cross-modality layernorm of the semantic tower 464 are fed each iteration into the cross-MHA network of the visual tower 462. In this way, visual features are integrated with semantic features. In operation, each of the visual tower 462 and the semantic tower 464 iterates m times—that is, the cross-modality network 460 effectively iterates m times. In some embodiments, m is equal to 2, such that the visual tower 462 and the semantic tower 464 each iterate (e.g., via a loop) 2 times; however, other values of m can be used. In some embodiments, a MHA block configured with 8 heads is used to facilitate co-attention learning; however, other MHA block sizes can be used.

The operations of the cross-attention module 410 can be expressed as a set of equations:

$$\begin{matrix}{Z}_{i}^{txt} = {Encoder}_{l - 1}^{sem} ( {Z}_{i - 1}^{txt} ) , & l = 1 , … , n\end{matrix} , \qquad EQ . 3$$

$${\tilde{Z}}_{0}^{txt} = {Z}_{n}^{txt} , \qquad EQ . 4$$

$${\tilde{Z}}_{k}^{txt} , {Z}_{k}^{img} = {𝒞ℳ𝒯}_{k - 1} ( {\tilde{Z}}_{k - 1}^{txt} , {Z}_{k - 1}^{img} ) , k = 1 , … , m \qquad EQ . 5$$

where

$${Encoder}_{l - 1}^{sem}$$

respective iterations of the semantic encoder 455, and
CMTₖ₋₁ represents respective iterations of the cross-modality network 460.

After the m iterations, the visual tower 462 provides the output visual-fused features, V_{FUSE} 468=(Zₘ^{IMG}), as the output from the cross-modality network 460, providing for self-attention and cross-attention of the two modality features.

Some or all components and/or features in the cross-attention module 410 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the cross-attention module 410 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the cross-attention module 410 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4C provides a block diagram illustrating an example of a text-image residual gating network 420 for use in a multimodality alignment module (such as the multimodality alignment module 400 in FIG. 4A) according to one or more embodiments, with reference to components and features described herein including but not limited to the figures and associated description. The text-image residual gating network 420 provides a gating model for modifying image features based on text rather than creating a new feature space. To achieve better alignment, the gating model does not rely solely on extracted visual features, but employs semantic-attended visual features (V_{FUSE}) (e.g., V_{FUSE} 468, FIG. 4B) in fusion to produce fused features 229. The gating feature of the gating model seeks to retain the image features when the text prompt is less informative. As illustrated in FIG. 4C, the text-image residual gating network 420 implements a set of equations as follows:

h=W_{gate}f_{gate}+Wᵣₑₛ(1−_{gate})⊙fᵣₑₛ, EQ. 6

f_{gate}=ConυNet₂(ConυNet₁([v_{fuse};s₂])⊙f_{img}, EQ. 7

fᵣₑₛ=Conυ(ConυNet₃([v_{fuse};s₂])) EQ. 8
where W_{gate} and Wᵣₑₛ are the weights for the gating (f_{gate}) 483 and residual features (fᵣₑₛ) 485 respectively, ⊙ represents the element-wise product, and [V_{FUSE}; S_{Z}] denotes concatenation of V_{FUSE} and S_{Z}. ConυNet() is a sequence with a conventional layer, activation function (ReLU for ConυNet₁ and ConυNet₃, and σ for ConυNet₂), and batch normalization before each activation, and Conυ() is the convolutional layer without a following activation function. The resulting compose features (h) from EQ. 5 provides the output fused features 229, which are then fed to the image generator decoder 230 to produce the generated image 120 (training) or the generated image 170 (inference).

Some or all components and/or features in the text-image residual gating network 420 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the text-image residual gating network 420 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the text-image residual gating network 420 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

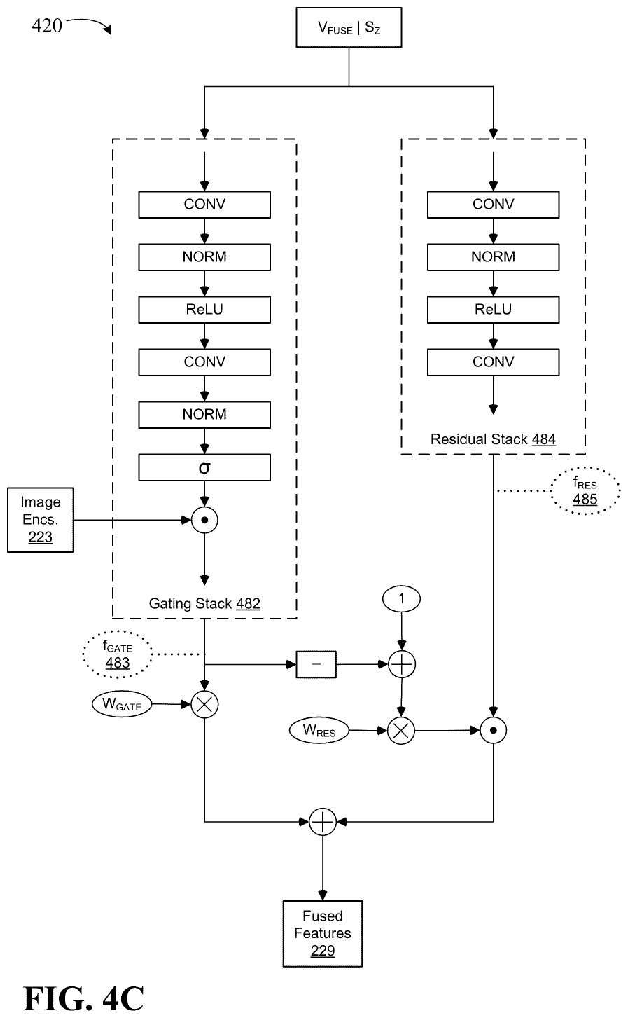

FIG. 5 provides a block diagram illustrating an example of a discriminator network 500 for use in a text-to-image generation system according to one or more embodiments, with reference to components and features described herein including but not limited to the figures and associated description. In embodiments, the discriminator network 500 corresponds to the discriminator network 114 (FIG. 1A, already discussed). The discriminator network 500 forms a negative pair discriminator that distinguishes between the generated images and negative samples, and also penalizes the model if it fails to handle minor disturbances on informative tokens. While conventional GANs have a discriminator that merely attempts to distinguish real from generated (“fake”) data, the negative pair discriminator of the discriminator network 500 also operates to identify specific data characteristics that enable the discriminator network 500 to (a) distinguish real images from fake ones, (b) discern paired image-text sets from unpaired ones in order to ensure that the generated image is related to the input text prompt, and (c) encourage the generator model to generate varied images when the original informative content in the inputs is disturbed.

As shown in FIG. 5, the discriminator network 500 includes a negative sample generator 510, a local discriminator 520, a text-conditioned global discriminator 530, an information-sensitive global discriminator 540, and an adversarial loss module 550. The discriminator network 500 operates in training mode (but not in inference mode) and receives as input the input data 101 (including the image canvas 102 and the text prompt 104), the current generated image 120 from the generator network (such as, e.g., the generator network 112 in FIG. 1A or the generator network 200 in FIG. 2A, already discussed), as well as training data sets 108. The discriminator network 500 operates to produce discriminator feedback and generator feedback during training.

The negative sample generator 510 receives as input the input data 101 (including image canvas 102 and text prompt 104), along with the training data sets 108, and operates to generate or select samples (e.g., image and text prompt set). Selected samples are from the training data sets 108. The samples to be selected or generated depend on which of the various respective discriminator types (e.g., the local discriminator 520, the text-conditioned global discriminator 530, and the information-sensitive global discriminator 540), is currently active—where each of the discriminators will be active sequentially during the training session. The samples provided for each discriminator type are provided in Table 1:

TABLE 1

| Discriminator Type | Samples |
|---|---|
| local discriminator 520 | ground truth image |
| text-conditioned global discriminator 530 | unpaired image/text |
| information-sensitive global discriminator 540 | image/disturbed text |

When the active discriminator is the local discriminator 520, the negative sample generator 510 selects a ground truth image corresponding to the text prompt 104—that is, the ground truth image is identified as the image that should be generated based on the text prompt 104. When the active discriminator is the text-conditioned global discriminator 530, the negative sample generator 510 selects an unpaired image and text set—that is, an image that does not correspond to the generated text. When the active discriminator is the information-sensitive global discriminator 540, the negative sample generator 510 generates an image and disturbed text set—that is, an image that corresponds to particular text, where the text is then disturbed (e.g., modified). The selected/generated sample sets as described are then provided to the respective discriminator, when active, during operation of the discriminator network 500.

### U-Net Based Local Discriminator

As shown in FIG. 5, the local discriminator 520 is a U-Net based local discriminator that includes a U-Net encoder 521 and a U-Net decoder 522. The local discriminator 520 targets specific local features within the data to detect discrepancies between real and fake data on a per-pixel basis, segmenting the image into real and fake regions. The local discriminator 520 is operated according to the following equations:

$${d}_{u N e t}^{real} = {D}_{dec} ( {D}_{e n c} ( {x}_{t} ) ) \qquad EQ . 9$$

$${d}_{u N e t}^{fake} = {D}_{dec} ( {D}_{e n c} ( {\tilde{x}}_{t} ) ) \qquad EQ . 10$$

where D_{enc} and D_{dec} are the U-Net encoder 521 and the U-Net decoder 522, respectively, Xₜ is the ground truth real image, and \tilde{x}ₜ is the generated image 120. That is, the local discriminator 520 is operated twice—once for the ground truth real image and once for the generated image 120. The outputs of the local discriminator 520 (i.e., d_{uNet}^{real} and d_{uNet}^{fake}) are pixel-wise local discriminations (e.g., predictions of real versus fake) that are provided to the adversarial loss module 550.

### Text-Conditioned Global Discriminator

The text-conditioned global discriminator 530 is to globally evaluate the relationship between text and image. This enables the discriminator to differentiate between images from the ground truth (real images), unpaired ones, and generated ones, and provides for effective discrimination between paired and unpaired sets, generating a scalar that indicates if the image is related to the text prompt rather than an unpaired or randomly sampled negative text prompt:

$${d}_{t e x t - G}^{fake} = {D}_{G} ( {D}_{e n c} ( {\tilde{x}}_{t} ) - {D}_{e n c} ( {x}_{b g} ) , s ) \qquad EQ . 11$$

$${d}_{t e x t - G}^{real} = {D}_{G} ( {D}_{e n c} ( {x}_{t} ) - {D}_{e n c} ( {x}_{b g} ) , s ) \qquad EQ . 12$$

$${d}_{t e x t - G}^{unpair} = {D}_{G} ( {D}_{e n c} ( {x}_{t} \$ ) - {D}_{e n c} ( {x}_{b g} ) , sr ) \qquad EQ . 13$$

where D_{G}(*) is the text-conditioned global discriminator; D_{G}(*) is a convolutional encoder module. The text- text-conditioned global discriminator D_{G}(*) receives as inputs the sentence features 213 (s) and the difference between the encoded canvas image (x_{bg}) and the encoded image (e.g., generated image \tilde{x}ₜ in EQ. 11, the ground truth image xₜ in EQ. 12, or the unpaired image xₜ$ in EQ. 13). In EQ. 13, which seeks a measure for unpaired image/text data, the sentence features 213 (s) are replaced with (sr), which is randomly-sampled from the training data set 108. That is, the text-conditioned global discriminator 530 is operated three times—once for the ground truth real image, once for the generated image 120, and once for the generated unpaired sample set. The text-conditioned global discrimination outputs

$$( i . e . , {d}_{t e x t - G}^{real} , {d}_{t e x t - G}^{fake} , and {d}_{t e x t - G}^{unpair} )$$

are provided to the adversarial loss module 550.

### Information-Sensitive Global Discriminator

The information-sensitive global discriminator 540 is sensitive to the information content, detecting variations in images resulting from disturbances in the original text inputs:

d_{info-G}=SIM (\tilde{x}ₜ, xₜ^{s*}) EQ. 14

where SIM () is a similarity function, \tilde{x}ₜ is the generated image 120, and xₜ^{s*} is the image generated from the prompt where the informative tokens have been disturbed. Informative tokens are defined as attributes (e.g., nouns, adjectives, etc.) and relations (e.g., adpositions, verbs) based on tokens in the sentences from the Part-of-Speech Tagset (POS tag). In embodiments, a normalized cosine similarity is used as the similarity function to encourage the dissimilarity of two generated images when the tokens have been disturbed; the goal is to have the system produce an entirely different image when the informative tokens are disturbed. The similarity/comparison is based on the original generated image and the image generated from the disturbed text, with two sets running concurrently in the information-sensitive global discriminator 540. The information-sensitive global discrimination results (i.e., d_{info-G}) are provided to the adversarial loss module 550.

The adversarial loss module 550 produces, for training purposes, generator feedback 560 for the generator network (e.g., the generator network 112 or the generator network 200) and discriminator feedback 570 that is fed back into components of the discriminator (e.g., the discriminator network 114 or the discriminator network 500). The adversarial loss module 550 defines a loss function for the discriminator (discriminator feedback 570) given by:

$${ℒ}_{𝒟} = {ℒ}_{uNet}^{𝒟} + \frac{1}{2} ( {ℒ}_{info - G}^{𝒟} + {ℒ}_{txt - G}^{𝒟} ) \qquad EQ . 15$$

$$where$$

$${ℒ}_{uNet}^{𝒟} = - 𝔼 [ min ( 0 , - 1 + {d}_{uNet}^{real} ) ] - 𝔼 [ min ( 0 , - 1 - {d}_{uNet}^{fake} ) ] \qquad EQ . 16$$

$${ℒ}_{info - G}^{𝒟} = 𝔼 [ {d}_{info - G} ] \qquad EQ . 17$$

$${ℒ}_{txt - G}^{𝒟} = - 𝔼 [ min ( 0 , - 1 + {d}_{txt - G}^{real} ) ] - 𝔼 [ min ( 0 , - 1 - {d}_{txt - G}^{fake} ) ] - 𝔼 [ min ( 0 , - 1 - {d}_{txt - G}^{unpair} ) ] \qquad EQ . 18$$

As shown by EQs. 15-18, the loss function evaluates the outputs of the local discriminator 520 (i.e., d_{uNet}^{real} and d_{uNet}^{fake}), the text-conditioned global discriminator 530 (i.e., d_{text-G}^{real}, d_{text-G}^{fake}, and d_{text-G}^{unpair}), and the information-sensitive global discriminator 540 (i.e., d_{info-G}). The function E |*| represents an expectation function (e.g., relating to the expected value or mean) that is used to calculate the expected difference or error between the predicted outcomes and the actual values. The discriminator loss measures how well the discriminator network distinguishes real data from negative data generated by the generator, and the discriminator network parameters are updated to minimize this loss, thereby improving its accuracy.

The adversarial loss module 550 further defines a loss function for the generator (generator feedback 560) given by:

[symbol]

_{G}= [symbol] _{uNet}^{G}+ [symbol] _{txt-G}^{G} EQ. 19
where

$${ℒ}_{uNet}^{G} = - 𝔼 [ {d}_{uNet}^{fake} ] \qquad EQ . 19$$

$${ℒ}_{txt - G}^{𝒟} = - 𝔼 [ {d}_{txt - G}^{fake} ] \qquad EQ . 20$$

The generator loss is based on how effectively the generator network fools the discriminator network into concluding that the generated (i.e., fake) data is real, and the generator network parameters are updated to minimize this loss, enhancing its ability to create realistic data. This adversarial process of parameter updates (generator and discriminator) during training leads to the gradual improvement of both the discriminator network and the generator network.

Some or all components and/or features in the discriminator network 500 can be implemented using one or more of a CPU, a GPU, an AI accelerator, an FPGA accelerator, an ASIC, and/or via a processor with software, or in a combination of a processor with software and an FPGA or ASIC, and/or in an AI/deep learning framework, such as, e.g., OpenVINO, PyTorch, Tensorflow, etc. or any similar framework. More particularly, components and/or features of the discriminator network 500 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations by the discriminator network 500 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

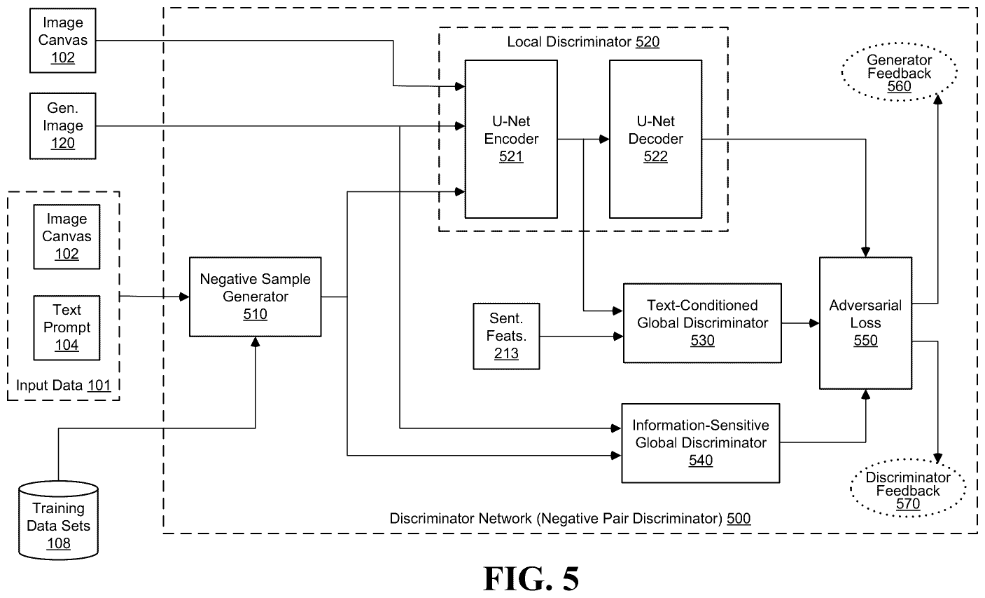

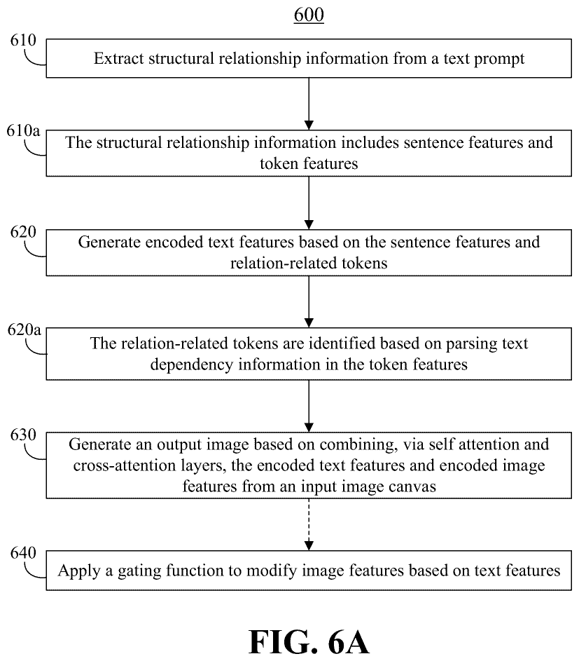

FIG. 6A provides a flow diagram illustrating an example method 600 of generating an image via a generator network according to one or more embodiments, with reference to components and features described herein including but not limited to the figures and associated description. The method 600 can generally be implemented in the text-to-image generation system 100 (FIG. 1A, already discussed) and/or the text-to-image generation system 150 (FIG. 1A, already discussed), via the generator network 200 (FIG. 2, already discussed), and/or in an AI/deep learning framework, such as, e.g., OpenVINO, PyTorch, Tensorflow, etc. or any similar framework. More particularly, the method 600 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 600 and/or functions associated therewith can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 610 provides for extracting structural relationship information from a text prompt, where at block 610a the structural relationship information includes sentence features and token features. Illustrated processing block 620 provides for generating encoded text features based on the sentence features and on relation-related tokens, where at block 620a the relation-related tokens are identified based on parsing text dependency information in the token features. Illustrated processing block 630 provides for generating an output image based on combining, via self attention and cross-attention layers, the encoded text features and encoded image features from an input image canvas.

In some embodiments, the method 600 further includes, at illustrated processing block 640, applying a gating function to modify image features based on text features. In some embodiments, the self attention and cross-attention layers are applied via a cross-modality network, and the gating function is applied via a residual gating network. In some embodiments, the relation-related tokens are further identified via an attention matrix.

FIG. 6B provides a flow diagram illustrating an example method 650 of training a generator network according to one or more embodiments, with reference to components and features described herein including but not limited to the figures and associated description. The method 650 can generally be implemented in the text-to-image generation system 100 (FIG. 1A, already discussed), via the discriminator network 500 (FIG. 5, already discussed), and/or in an AI/deep learning framework, such as, e.g., OpenVINO, PyTorch, Tensorflow, etc. or any similar framework. More particularly, the method 650 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 650 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 660 provides for training the generator network based on determining, via a discriminator network, differences between the output image from the generator network and a negative sample image, where at block 660a the generator network and the discriminator network form a modified generative adversarial network. Illustrated processing block 670 provides for generating an adversarial loss based on determining a first value relating to a degree to which an image is related to the text prompt or an unpaired or randomly sampled negative text prompt. Illustrated processing block 680 provides for generating the adversarial loss based further on determining a second value relating to dissimilarity between the output image from the generator network and an image generated based on text disturbances. In some embodiments, the operations of block 660 are performed at least in part by a local discriminator. In some embodiments, the operations of block 670 are performed at least in part by a text-conditioned global discriminator. In some embodiments, the operations of block 680 are performed at least in part by an information-sensitive global discriminator.

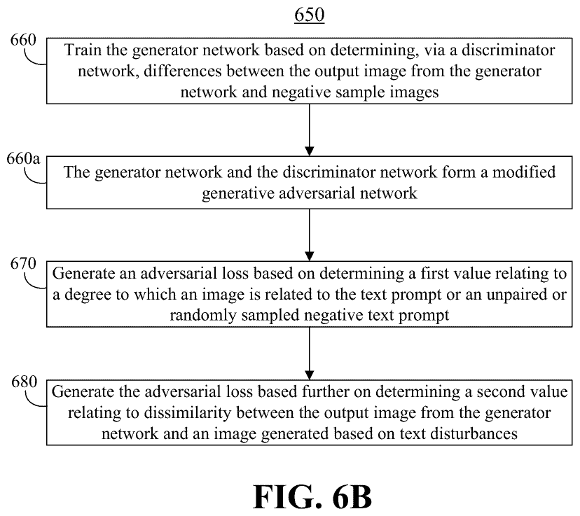

FIG. 7 shows a block diagram illustrating an example performance-enhanced computing system 10 for structure-based text-to-image generation according to one or more embodiments, with reference to components and features described herein including but not limited to the figures and associated description. The system 10 can generally be part of an electronic device/platform having computing and/or communications functionality (e.g., a server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry, or other wearable devices), vehicular functionality (e.g., car, truck, motorcycle), robotic functionality (e.g., robot or autonomous robot), Internet of Things (IoT) functionality, etc., or any combination thereof. In the illustrated example, the system 10 can include a host processor 12 (e.g., central processing unit/CPU) having an integrated memory controller (IMC) 14 that can be coupled to system memory 20. The host processor 12 can include any type of processing device, such as, e.g., microcontroller, microprocessor, RISC processor, ASIC, etc., along with associated processing modules or circuitry. The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 can also include an input/output (I/O) module 16. The I/O module 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/ or the I/O module 16 can communicate with the storage 22 (all or portions thereof) via a network controller 24. In some embodiments, the system 10 can also include a graphics processor 26 (e.g., a graphics processing unit/GPU and/or an AI accelerator 27. In an embodiment, the system 10 can also include a vision processing unit (VPU), not shown.

The host processor 12 and the I/O module 16 can be implemented together on a semiconductor die as a system on chip (SoC) 11, shown encased in a solid line. The SoC 11 can therefore operate as a computing apparatus for structure-based text-to-image generation. In some embodiments, the SoC 11 can also include one or more of the system memory 20, the network controller 24, and/or the graphics processor 26 (shown encased in dotted lines). In some embodiments, the SoC 11 can also include other components of the system 10.

The host processor 12 and/or the I/O module 16 can execute program instructions 28 retrieved from the system memory 20 and/or the storage 22 to perform one or more aspects of the method 600 and/or the method 650 as described herein with reference to FIGS. 6A-6B. The system 10 can implement one or more aspects of as described herein with reference to FIGs. FIGS. 1A-1B, 2A-2C, 3, 4A-4C, 5, and/or 6A-6B. The system 10 is therefore considered to be performance-enhanced at least to the extent that the technology provides for generating images that accurately reflect and align with the relational context of the input text.

Computer program code to carry out the processes described above can be written in any combination of one or more programming languages, including an object-oriented programming language such as JAVA, JAVASCRIPT, PYTHON, SMALLTALK, C++or the like and/or conventional procedural programming languages, such as the “C” programming language or similar programming languages, and implemented as program instructions 28. Additionally, program instructions 28 can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touchscreen, keyboard, mouse, cursor-control device, microphone, digital camera, video recorder, camcorder, biometric scanners and/or sensors; input devices can be used to enter information and interact with system 10 and/or with other devices. The I/O devices 17 can also include one or more of output devices, such as a display (e.g., touchscreen, liquid crystal display/LCD, light emitting diode/LED display, plasma panels, etc.), speakers and/or other visual or audio output devices. The input and/or output devices can be used, e.g., to provide a user interface.

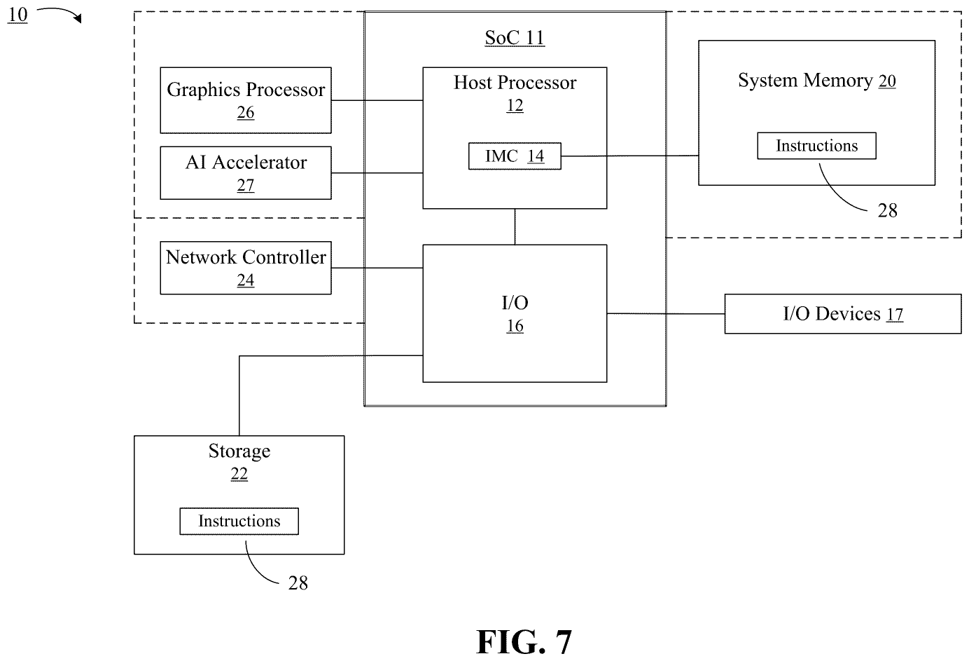

FIG. 8 shows a block diagram illustrating an example semiconductor apparatus 30 for structure-based text-to-image generation according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 7. The logic 34 can implement one or more aspects of the processes described above, including the method 600 and/or the method 650. The logic 34 can implement one or more aspects of the text-to-image generation system 100, the text-to-image generation system 150, the generator network 200, the relation understanding module 210, the multimodality fusion module 220, the relation enhancing module 300, the multimodality alignment module 400, the cross-attention module 410, the text-image residual gating network 420, and/or the discriminator network 500 as described herein with reference to FIGS. 1A-1B, 2A-2C, 3, 4A-4C, 5, and/or 6A-6B. The apparatus 30 is therefore considered to be performance-enhanced at least to the extent that the technology provides for generating images that accurately reflect and align with the relational context of the input text.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 32.

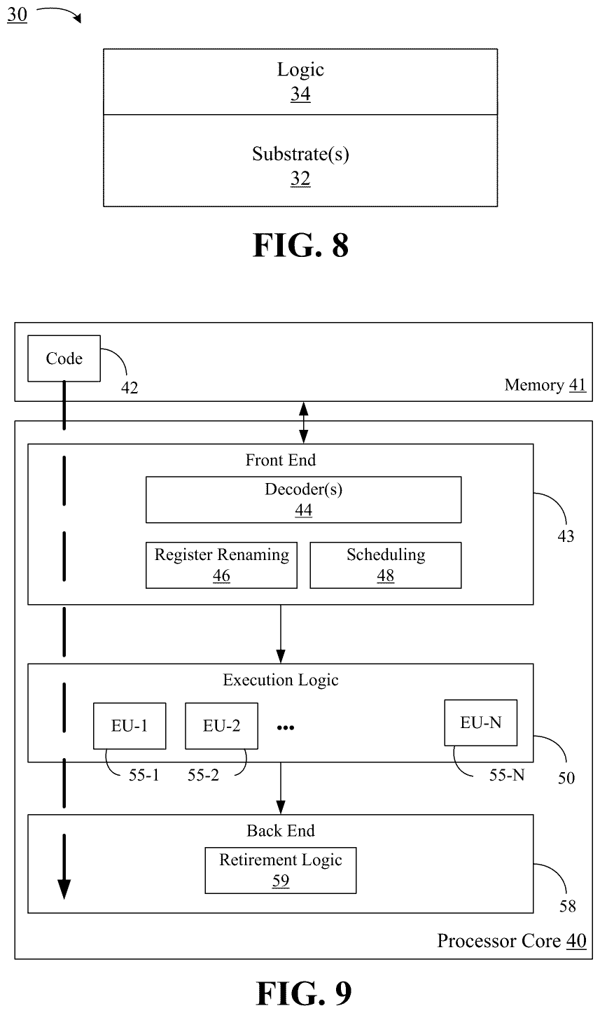

FIG. 9 is a block diagram illustrating an example processor core 40 according to one or more embodiments, with reference to components and features described herein including but not limited to the figures and associated description. The processor core 40 can be the core for any type of processor, such as a micro-processor, an embedded processor, a digital signal processor (DSP), a network processor, a graphics processing unit (GPU), or other device to execute code. Although only one processor core 40 is illustrated in FIG. 9, a processing element can alternatively include more than one of the processor core 40 illustrated in FIG. 9. The processor core 40 can be a single-threaded core or, for at least one embodiment, the processor core 40 can be multithreaded in that it can include more than one hardware thread context (or “logical processor”) per core.

FIG. 9 also illustrates a memory 41 coupled to the processor core 40. The memory 41 can be any of a wide variety of memories (including various layers of memory hierarchy) as are known or otherwise available to those of skill in the art. The memory 41 can include one or more code 42 instruction(s) to be executed by the processor core 40. The code 42 can implement one or more aspects of the method 600 and/or the method 650 described above. The processor core 40 can implement one or more aspects of the text-to-image generation system 100, the text-to-image generation system 150, the generator network 200, the relation understanding module 210, the multimodality fusion module 220, the relation enhancing module 300, the multimodality alignment module 400, the cross-attention module 410, the text-image residual gating network 420, and/or the discriminator network 500 as described herein with reference to FIGS. 1A-1B, 2A-2C, 3, 4A-4C, 5, and/or 6A-6B. The processor core 40 can follow a program sequence of instructions indicated by the code 42. Each instruction can enter a front end portion 43 and be processed by one or more decoders 44. The decoder 44 can generate as its output a micro operation such as a fixed width micro operation in a predefined format, or can generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

The processor core 40 is shown including execution logic 50 having a set of execution units 55-1 through 55-N. Some embodiments can include a number of execution units dedicated to specific functions or sets of functions. Other embodiments can include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 can take a variety of forms as known to those of skill in the art (e.g., re-order buffers or the like). In this manner, the processor core 40 is transformed during execution of the code 42, at least in terms of the output generated by the decoder, the hardware registers and tables utilized by the register renaming logic 46, and any registers (not shown) modified by the execution logic 50.

Although not illustrated in FIG. 9, a processing element can include other elements on chip with the processor core 40. For example, a processing element can include memory control logic along with the processor core 40. The processing element can include I/O control logic and/or can include I/O control logic integrated with memory control logic. The processing element can also include one or more caches.

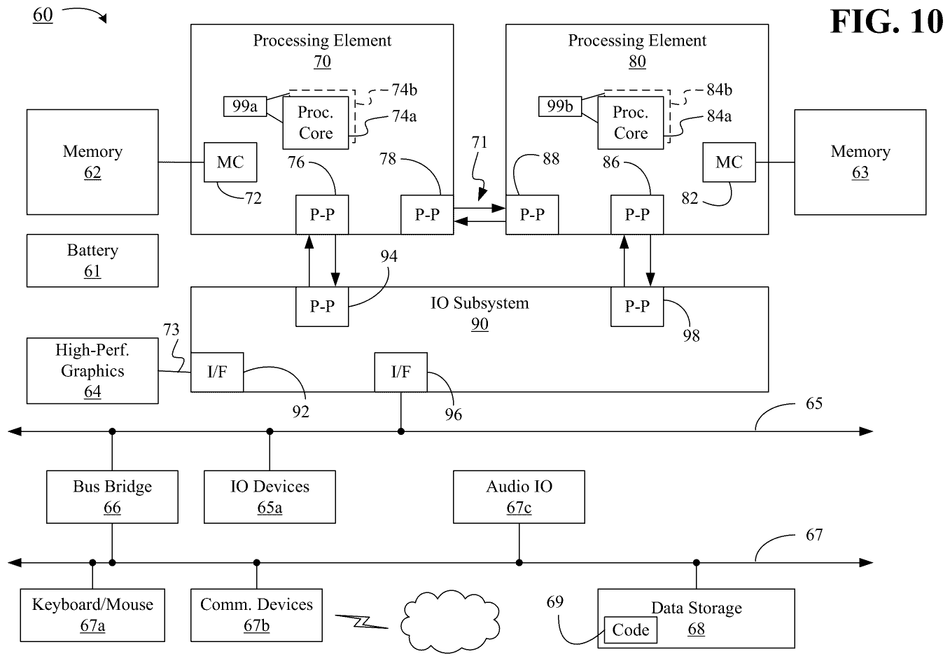

FIG. 10 is a block diagram illustrating an example of a multi-processor based computing system 60 according to one or more embodiments, with reference to components and features described herein including but not limited to the figures and associated description. The multiprocessor system 60 includes a first processing element 70 and a second processing element 80. While two processing elements 70 and 80 are shown, it is to be understood that an embodiment of the system 60 can also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 10 can be implemented as a multi-drop bus rather than point-to-point interconnect.

As shown in FIG. 10, each of the processing elements 70 and 80 can be multicore processors, including first and second processor cores (i.e., processor cores 74a and 74b and processor cores 84a and 84b). Such cores 74a, 74b, 84a, 84b can be configured to execute instruction code in a manner similar to that discussed above in connection with FIG. 9.

Each processing element 70, 80 can include at least one shared cache 99a, 99b. The shared cache 99a, 99b can store data (e.g., instructions) that are utilized by one or more components of the processor, such as the cores 74a, 74b and 84a, 84b, respectively. For example, the shared cache 99a, 99b can locally cache data stored in a memory 62, 63 for faster access by components of the processor. In one or more embodiments, the shared cache 99a, 99b can include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments is not so limited. In other embodiments, one or more additional processing elements can be present in a given processor. Alternatively, one or more of the processing elements 70, 80 can be an element other than a processor, such as an accelerator or a field programmable gate array. For example, additional processing element(s) can include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences can effectively manifest themselves as asymmetry and heterogeneity amongst the processing elements 70, 80. For at least one embodiment, the various processing elements 70, 80 can reside in the same die package.

The first processing element 70 can further include memory controller logic (MC) 72 and point-to-point (P-P) interfaces 76 and 78. Similarly, the second processing element 80 can include a MC 82 and P-P interfaces 86 and 88. As shown in FIG. 10, MC's 72 and 82 couple the processors to respective memories, namely a memory 62 and a memory 63, which can be portions of main memory locally attached to the respective processors. While the MC 72 and 82 is illustrated as integrated into the processing elements 70, 80, for alternative embodiments the MC logic can be discrete logic outside the processing elements 70, 80 rather than integrated therein.

The first processing element 70 and the second processing element 80 can be coupled to an I/O subsystem 90 via P-P interconnects 76 and 86, respectively. As shown in FIG. 10, the I/O subsystem 90 includes P-P interfaces 94 and 98. Furthermore, the I/O subsystem 90 includes an interface 92 to couple I/O subsystem 90 with a high performance graphics engine 64. In one embodiment, a bus 73 can be used to couple the graphics engine 64 to the I/O subsystem 90. Alternately, a point-to-point interconnect can couple these components.

In turn, the I/O subsystem 90 can be coupled to a first bus 65 via an interface 96. In one embodiment, the first bus 65 can be a Peripheral Component Interconnect (PCI) bus, or a bus such as a PCI Express bus or another third generation I/O interconnect bus, although the scope of the embodiments are not so limited.

As shown in FIG. 10, various I/O devices 65a (e.g., biometric scanners, speakers, cameras, and/or sensors) can be coupled to the first bus 65, along with a bus bridge 66 which can couple the first bus 65 to a second bus 67. In one embodiment, the second bus 67 can be a low pin count (LPC) bus. Various devices can be coupled to the second bus 67 including, for example, a keyboard/mouse 67a, communication device(s) 67b, and a data storage unit 68 such as a disk drive or other mass storage device which can include code 69, in one embodiment. The illustrated code 69 can implement one or more aspects of the processes described above, including the method 600 and/or the method 650. The illustrated code 69 can be similar to the code 42 (FIG. 9), already discussed. Further, an audio I/O 67c can be coupled to second bus 67 and a battery 61 can supply power to the computing system 60. The system 60 can implement one or more aspects of the text-to-image generation system 100, the text-to-image generation system 150, the generator network 200, the relation understanding module 210, the multimodality fusion module 220, the relation enhancing module 300, the multimodality alignment module 400, the cross-attention module 410, the text-image residual gating network 420, and/or the discriminator network 500 as described herein with reference to FIGS. 1A-1B, 2A-2C, 3, 4A-4C, 5, and/or 6A-6B.

Note that other embodiments are contemplated. For example, instead of the point-to-point architecture of FIG. 10, a system can implement a multi-drop bus or another such communication topology. Also, the elements of FIG. 10 can alternatively be partitioned using more or fewer integrated chips than shown in FIG. 10.

Embodiments of each of the above systems, devices, components and/or methods, including the text-to-image generation system 100, the text-to-image generation system 150, the generator network 200, the relation understanding module 210, the multimodality fusion module 220, the relation enhancing module 300, the multimodality alignment module 400, the cross-attention module 410, the text-image residual gating network 420, the discriminator network 500, the method 600, the method 650, and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits. For example, embodiments of each of the above systems, devices, components and/or methods can be implemented via the system 10 (FIG. 7, already discussed), the semiconductor apparatus 30 (FIG. 8, already discussed), the processor 40 (FIG. 9, already discussed), and/or the computing system 60 (FIG. 10, already discussed).

Alternatively, or additionally, all or portions of the foregoing systems and/or devices and/or components and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples

Example S1 includes a performance-enhanced computing system, comprising a processor, and a memory coupled to the processor, the memory including a set of instructions which, when executed by the processor, cause the computing system to extract structural relationship information from a text prompt, wherein the structural relationship information includes sentence features and token features, generate encoded text features based on the sentence features and relation-related tokens, wherein the relation-related tokens are to be identified based on parsing text dependency information in the token features, and generate an output image based on combining, via self attention and cross-attention layers, the encoded text features and encoded image features from an input image canvas.

Example S2 includes the computing system of Example S1, wherein the instructions, when executed, further cause the computing system to apply a gating function to modify image features based on text features.

Example S3 includes the computing system of Example S1 or S2, wherein the self attention and cross-attention layers are to be applied via a cross-modality network, and wherein the gating function is to be applied via a residual gating network.

Example S4 includes the computing system of any of Examples S1-S3, wherein the relation-related tokens are to be further identified via an attention matrix.

Example S5 includes the computing system of any of Examples S1-S4, wherein the instructions, when executed, further cause the computing system to train the generator network based on determining, via a discriminator network, differences between the output image from the generator network and negative sample images, wherein the generator network and the discriminator network form a modified generative adversarial network (GAN).

Example S6 includes the computing system of any of Examples S1-S5, wherein to train the generator network, the instructions, when executed, further cause the computing system to generate an adversarial loss based on determining a first value relating to a degree to which an image is related to the text prompt or an unpaired or randomly sampled negative text prompt.

Example S7 includes the computing system of any of Examples S1-S6, wherein to train the generator network, the instructions, when executed, further cause the computing system to generate the adversarial loss based further on determining a second value relating to dissimilarity between the output image from the generator network and an image generated based on text disturbances.

Example C1 includes at least one computer readable storage medium comprising a set of instructions which, when executed by a computing device, cause the computing device to extract structural relationship information from a text prompt, wherein the structural relationship information includes sentence features and token features, generate encoded text features based on the sentence features and relation-related tokens, wherein the relation-related tokens are to be identified based on parsing text dependency information in the token features, and generate an output image based on combining, via self attention and cross-attention layers, the encoded text features and encoded image features from an input image canvas.

Example C2 includes the at least one computer readable storage medium of Example C1, wherein the instructions, when executed, further cause the computing device to applying a gating function to modify image features based on text features.

Example C3 includes the at least one computer readable storage medium of Example C1 or C2, wherein the self attention and cross-attention layers are to be applied via a cross-modality network, and wherein the gating function is to be applied via a residual gating network.

Example C4 includes the at least one computer readable storage medium of any of Examples C1-C3, wherein the relation-related tokens are to be further identified via an attention matrix.

Example C5 includes the at least one computer readable storage medium of any of Examples C1-C4, wherein the instructions, when executed, further cause the computing device to train the generator network based on determining, via a discriminator network, differences between the output image from the generator network and negative sample images, wherein the generator network and the discriminator network form a modified generative adversarial network (GAN).

Example C6 includes the at least one computer readable storage medium of any of Examples C1-C5, wherein to train the generator network, the instructions, when executed, further cause the computing device to generate an adversarial loss based on determining a first value relating to a degree to which an image is related to the text prompt or an unpaired or randomly sampled negative text prompt.

Example C7 includes the at least one computer readable storage medium of any of Examples C1-C6, wherein to train the generator network, the instructions, when executed, further cause the computing device to generate the adversarial loss based further on determining a second value relating to dissimilarity between the output image from the generator network and an image generated based on text disturbances.

Example M1 includes a method of generating an image via a generator network, comprising extracting structural relationship information from a text prompt, wherein the structural relationship information includes sentence features and token features, generating encoded text features based on the sentence features and on relation-related tokens, wherein the relation-related tokens are identified based on parsing text dependency information in the token features, and generating an output image based on combining, via self attention and cross-attention layers, the encoded text features and encoded image features from an input image canvas.

Example M2 includes the method of Example M1, further comprising applying a gating function to modify image features based on text features.

Example M3 includes the method of Example M1 or M2, wherein the self attention and cross-attention layers are applied via a cross-modality network, and wherein the gating function is applied via a residual gating network.

Example M4 includes the method of any of Examples M1-M3, wherein the relation-related tokens are further identified via an attention matrix.

Example M5 includes the method of any of Examples M1-M4, further comprising training the generator network based on determining, via a discriminator network, differences between the output image from the generator network and negative sample images, wherein the generator network and the discriminator network form a modified generative adversarial network (GAN).

Example M6 includes the method of any of Examples M1-M5, wherein training the generator network further comprises generating an adversarial loss based on determining a first value relating to a degree to which an image is related to the text prompt or an unpaired or randomly sampled negative text prompt.

Example M7 includes the method of any of Examples M1-M6, wherein training the generator network further comprises generating the adversarial loss based further on determining a second value relating to dissimilarity between the output image from the generator network and an image generated based on text disturbances.

Example A1 includes a semiconductor apparatus comprising one or more substrates, and logic coupled to the one or more substrates, wherein the logic is implemented at least partly in one or more of configurable logic or fixed-functionality hardware logic, the logic to extract structural relationship information from a text prompt, wherein the structural relationship information includes sentence features and token features, generate encoded text features based on the sentence features and relation-related tokens, wherein the relation-related tokens are to be identified based on parsing text dependency information in the token features, and generate an output image based on combining, via self attention and cross-attention layers, the encoded text features and encoded image features from an input image canvas.

Example A2 includes the apparatus of Example A1, wherein the logic is to apply a gating function to modify image features based on text features.

Example A3 includes the apparatus of Example A1 or A2, wherein the self attention and cross-attention layers are to be applied via a cross-modality network, and wherein the gating function is to be applied via a residual gating network.

Example A4 includes the apparatus of any of Examples A1-A3, wherein the relation-related tokens are to be further identified via an attention matrix.

Example A5 includes the apparatus of any of Examples A1-A4, wherein the logic is to train the generator network based on determining, via a discriminator network, differences between the output image from the generator network and negative sample images, wherein the generator network and the discriminator network form a modified generative adversarial network (GAN).

Example A6 includes the apparatus of any of Examples A1-A5, wherein to train the generator network, the logic is to generate an adversarial loss based on determining a first value relating to a degree to which an image is related to the text prompt or an unpaired or randomly sampled negative text prompt.

Example A7 includes the apparatus of any of Examples A1-A6, wherein to train the generator network, the logic is to generate the adversarial loss based further on determining a second value relating to dissimilarity between the output image from the generator network and an image generated based on text disturbances.

Example AM1 includes an apparatus comprising means for performing the method of any of Examples M1 to M7.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), solid state drive (SSD)/NAND drive controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a processor; and
a memory coupled to the processor, the memory including a set of instructions which, when executed by the processor, cause the computing system to:
extract structural relationship information from a text prompt, wherein the structural relationship information includes sentence features and token features;
generate encoded text features based on the sentence features and relation-related tokens, wherein the relation-related tokens are to be identified based on parsing text dependency information in the token features; and
generate an output image based on combining, via self attention and cross-attention layers, the encoded text features and encoded image features from an input image canvas.

2. The computing system of claim 1, wherein the instructions, when executed, further cause the computing system to apply a gating function to modify image features based on text features.

3. The computing system of claim 2, wherein the self attention and cross-attention layers are to be applied via a cross-modality network, and wherein the gating function is to be applied via a residual gating network.

4. The computing system of claim 1, wherein the relation-related tokens are to be further identified via an attention matrix.

5. The computing system of claim 1, wherein the instructions, when executed, further cause the computing system to train the generator network based on determining, via a discriminator network, differences between the output image from the generator network and negative sample images;
wherein the generator network and the discriminator network form a modified generative adversarial network (GAN).

6. The computing system of claim 5, wherein to train the generator network, the instructions, when executed, further cause the computing system to generate an adversarial loss based on determining a first value relating to a degree to which an image is related to the text prompt or an unpaired or randomly sampled negative text prompt.

7. The computing system of claim 6, wherein to train the generator network, the instructions, when executed, further cause the computing system to generate the adversarial loss based further on determining a second value relating to dissimilarity between the output image from the generator network and an image generated based on text disturbances.

8. At least one computer readable storage medium comprising a set of instructions which, when executed by a computing device, cause the computing device to:
extract structural relationship information from a text prompt, wherein the structural relationship information includes sentence features and token features;
generate encoded text features based on the sentence features and relation-related tokens, wherein the relation-related tokens are to be identified based on parsing text dependency information in the token features; and
generate an output image based on combining, via self attention and cross-attention layers, the encoded text features and encoded image features from an input image canvas.

9. The at least one computer readable storage medium of claim 8, wherein the instructions, when executed, further cause the computing device to applying a gating function to modify image features based on text features.

10. The at least one computer readable storage medium of claim 9, wherein the self attention and cross-attention layers are to be applied via a cross-modality network, and wherein the gating function is to be applied via a residual gating network.

11. The at least one computer readable storage medium of claim 8, wherein the relation-related tokens are to be further identified via an attention matrix.

12. The at least one computer readable storage medium of claim 8, wherein the instructions, when executed, further cause the computing device to train the generator network based on determining, via a discriminator network, differences between the output image from the generator network and negative sample images;
wherein the generator network and the discriminator network form a modified generative adversarial network (GAN).

13. The at least one computer readable storage medium of claim 12, wherein to train the generator network, the instructions, when executed, further cause the computing device to generate an adversarial loss based on determining a first value relating to a degree to which an image is related to the text prompt or an unpaired or randomly sampled negative text prompt.

14. The at least one computer readable storage medium of claim 13, wherein to train the generator network, the instructions, when executed, further cause the computing device to generate the adversarial loss based further on determining a second value relating to dissimilarity between the output image from the generator network and an image generated based on text disturbances.

15. A method of generating an image via a generator network, comprising:
extracting structural relationship information from a text prompt, wherein the structural relationship information includes sentence features and token features;
generating encoded text features based on the sentence features and on relation-related tokens, wherein the relation-related tokens are identified based on parsing text dependency information in the token features; and
generating an output image based on combining, via self attention and cross-attention layers, the encoded text features and encoded image features from an input image canvas.

16. The method of claim 15, further comprising applying a gating function to modify image features based on text features.

17. The method of claim 16, wherein the self attention and cross-attention layers are applied via a cross-modality network, and wherein the gating function is applied via a residual gating network.

18. The method of claim 15, wherein the relation-related tokens are further identified via an attention matrix.

19. The method of claim 15, further comprising training the generator network based on determining, via a discriminator network, differences between the output image from the generator network and negative sample images;
wherein the generator network and the discriminator network form a modified generative adversarial network (GAN).

20. The method of claim 19, wherein training the generator network further comprises generating an adversarial loss based on determining a first value relating to a degree to which an image is related to the text prompt or an unpaired or randomly sampled negative text prompt and determining a second value relating to dissimilarity between the output image from the generator network and an image generated based on text disturbances.
